(19) United States
(12) Patent Application Publication
(10) Pub. No.: US 2009/0271240 A1
(43) Pub. Date: Oct. 29, 2009

(54) METHOD AND SYSTEM FOR STRATEGIC HEADCOUNT PLANNING WITH OPERATIONAL TRANSITION MANAGEMENT OF WORKFORCE

(75) Inventors: Tarun Kumar, Mohegan Lake, NY (US); Sameep Mehta, New Delhi (IN); Vinayaka D. Pandit, New Delhi (IN); Gyana R. Parija, Gurgaon (IN); Anupam Saronwala, New Delhi (IN); Rashmi Singh, New Delhi (IN)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/110,855

(22) Filed: Apr. 28, 2008

(51) Int. Cl. G06Q 30/00; G06F 9/46

(52) U.S. Cl. 705/8

(57) ABSTRACT

A method and system are disclosed for planning a workforce headcount for a given business process. The method comprises the steps of providing as inputs, i) productivity ramp-ups to model the level of experience and to measure the performance of both new hires and current employees, and ii) industry/market attrition rates for employees; and performing an evaluation, using said inputs, of at least one given management objective. On the basis of this evaluation, a future hiring and transition plan is provided for the given business process for a defined period of time. In the preferred embodiment of the invention, uncertainty is associated with one or more of the inputs, and the future hiring and transition plan is provided by using stochastic programming to model the uncertainty associated with at least one of said one or more of the inputs.

### BACKGROUND OF THE INVENTION

1. Field of the Invention

This invention generally relates to business planning, and more specifically, to strategic headcount planning for business processes. Even more specifically, the preferred embodiment of the invention relates to the use of a stochastic programming model to perform such headcount planning.

2. Background Art

In business it is becoming increasingly common for organizations to outsource various business processes to third party outsourcers. Some business processes that are now regularly outsourced include contact centers, accounting operations, human resources services, procurement, etc. This recent trend of outsourcing business processes has been largely caused by the ever-increasing requirements in terms of infrastructure and resources to perform such business processes. To this extent, three types of outsourcing commonly practiced are Business Process Outsourcing (BPO), Business Transformation Outsourcing (BTO), and Information Technology Outsourcing (ITO).

Under BPO, an outsourcer assumes responsibility for performing one or more business processes that were previously done by the client or another outsourcer. Business processes targeted for this form of outsourcing are seldom core business processes of the client. For instance, accounting and human resources are not core business processes unless the client generates its revenue primarily through its accounting or human resources services. When outsourced, the business processes are typically changed only slightly, if at all, but lower labor rates generally enable an overall reduction in the cost of performing the business processes. Information technology (IT) may or may not play a significant role in reducing the cost of the outsourced business processes.

Under BTO, an outsourcer also assumes business processes, but the business processes themselves may be substantially changed--often through IT and business process redesign. Furthermore, the business processes being outsourced may be core or non-core process. For instance, to a web-based retailer, shipping is a core business process that is usually outsourced because the outsourcers have more advanced technology and much larger scale. A transformational outsourcer may also be able to drive a change in the client's business strategy, for example, by serving global rather than just national markets. Furthermore, the outsourcer may be able to enhance the client's financial condition, for example, by acquiring some of the client's assets and hiring employees that it no longer needs to perform the processes.

Like BTO, ITO deals are often large, extremely complex transactions. Moreover, BTO thus may involve thousands of employees and business partners at hundreds of sites around the world. Likewise, hundreds of millions of dollars worth of assets may be involved. Even if the outsourcing transaction is smaller financially and limited to one country, other dimensions of the transaction, such as computers, software applications, and communication networks, may be quite complex.

BPO and other outsourcing companies hire employees and train them to manage business processes for the clients. The revenue of these companies is directly proportional to the amount of workload being managed and the productivity of the employees. Hence, these companies depend on highly skilled workforce to deliver services to its clients. With the attrition rate of around 40%, assessment and training of the workforce has become a key bottleneck to revenue growth. The hiring and training of the employees need to be planned keeping in mind the potential attritions, number of employees needed to manage current business processes and new employees needed for potential new business from the clients. Also, with adoption of Global Delivery Model, Service Level Agreements and downward pricing pressures, an effective workforce planning is the key to delivery excellence and revenue growth.

The business processes handled by BPO companies can be assigned to two sets: Voice Processes and Non-Voice Processes. Voice processes are those that need the agent to interact with the customer in real time using phone, instant message or one of the asynchronous means such as email or postal mail to respond to and resolve customer issues. The non-voice processes, also referred to, as back-office processes, do not need the agent to interact with the client. The BPO companies handle hundreds of processes for tens of clients.

An individual working for a BPO company on a process is called an agent. An agent is trained in executing a business process that he has access to through the clients IT infrastructure. A set of agents working on a process is organized as a team known as a batch. Each day, an agent is assigned a set of tasks called claims that belong to a specific client's business process, and the agent completes these tasks by following a set of business guidelines set forth by the client. The client outsources a set of related processes to the same BPO company. Generally a client outsources a parent process and a set of related affiliate processes. Each parent processes can have multiple affiliate processes within a process family. If a parent process does not have an affiliate, then it is an independent process. Affiliate processes need specialization over and above the parent process. Hence an agent is first trained in a parent process and after he has worked for a reasonable period in the parent process, he/she is then moved to one of the affiliate processes after an additional training specific to the affiliate. Also, the revenue per unit of work is higher for affiliate process.

The demand for each process is measured in number of claims (or unit of work) that need to be processed. Productivity of an agent is measured in number of claims processed per hour. After an agent is trained in a process, he undergoes a ramp-up in productivity until it reaches the optimal productivity levels. This happens for both a new hire as well as an in-transition agent. Further, a set of agents is assigned to a batch. This helps in managing a team of agents having similar productivity and working on the same process. These batches have minimum and maximum size limitations. The batch size can change as a result of either attrition or transition decisions.

There are numerous costs and uncertainty associated with the BPO industry. There are costs associated with hiring an agent, training him/her on one of the processes, costs related to attrition and costs in re-training him to work on affiliate or new process. There are several factors that account for the uncertainty in managing the processes, namely:
1. The future claim volume associated with current processes;
2. The introduction of new processes; and
3. Employee attrition.

Hence in order to run the business effectively, it is important to develop effective headcount planning and transition decisions to meet the demand subject to:
1. Uncertainty associated with the variable demand for the current processes as well as introduction of new processes;
2. Attrition levels that may affect the capability to meet the demand; and
3. Productivity ramp-up periods for new hires and transitioned agents.

### SUMMARY OF THE INVENTION

An object of this invention is to provide a solution for the headcount planning necessary to meet the business growth targets for a planning horizon.

Another object of the present invention is to enable BPO companies to evaluate their capacity to enable them to enter into optimal revenue sharing agreements with their clients by signing contracts for future work based on a precise workforce capability for the future.

A further object of this invention is to provide a method and system for strategic planning with operational deployment schedule of workforce for meeting Business Process Management Growth targets using a stochastic programming model to perform an effective headcount planning.

These and other objectives are attained with a method and system for planning a workforce headcount for a given business process. The method comprises the steps of providing as inputs, i) productivity ramp-ups to model the level of experience and to measure the performance of both new hires and current employees, and ii) industry/market attrition rates for employees; and performing an evaluation, using said inputs, of at least one given management objective. On the basis of this evaluation, a future hiring and transition plan is provided for the given business process for a defined period of time.

In the preferred embodiment of the invention, uncertainty is associated with one or more of the inputs, and the future hiring and transition plan is provided by using stochastic programming to model the uncertainty associated with at least one of said one or more of the inputs. Also, one or more scenario trees may be used to evaluate the impact of uncertain demand on the decision making process.

In addition, preferably, the future hiring and transition plan includes a headcount for the specified period that is determined based on a number of given factors including the sum of i) the employees currently working on the process, ii) new hires during said period, iii) the number of employees leaving during said period, and iv) the number of employees transitioning to affiliated processes.

The preferred embodiment of the invention, described in detail below, provides a model to enable BPOs to improve their operational efficiency and provide exceptional quality of service. The model uses stochastic programming approach to model uncertainty. Stochastic optimization refers to the minimization or maximization of a function in the presence of randomness. Stochastic optimization modeling has been recognized as an effective nonlinear optimization tool for various applications, including the solution of operations research and managerial problems. Stochastic optimization modeling has not previously been applied to the field of headcount planning for BPO.

The preferred embodiment of the present invention, thus, provides a method and a system employing stochastic-integer-programming-based constrained optimization technology to develop optimal headcount and transition plans for non-voice business process by employing as input, in a machine-readable data format:
1. A list of parent and related affiliate processes;
2. The number of future months of planning horizon;
3. One or more scenarios and the future start month and probability of each scenario. The sum of probability of all scenarios should add up to 1;
4. Transfer lead-time in months from parent to each affiliate scenario. Transfer lead-time is the time in months needed to train an agent working on the parent processes to transition to an affiliate process;
5. Cost of training an agent to be transferred from parent to affiliate process;
6. A list of batches corresponding to each scenario;
7. For existing batches, the start date and size of the batch;
8. For future batches, the future start-date of the batch;
9. For each process-scenario pair, the hiring cost per agent, the fraction attrition during each period and the minimum and maximum size of the batch;
10. For each process-batch-future month combination, the expected productivity in claims per hour; and
11. For each process the ramp-up in productivity in future months.

In addition, said method and system preferably employ data processing in a computer:
1. To analyze multiple scenarios and minimize the total workforce management cost across all scenarios. The workforce management cost is the sum of hiring cost, training cost, transition cost, excess hiring penalty cost and agent shortage penalty cost. Alternatively, minimize the unmet demand across all the processes;
2. To generate, in a machine-readable data format, a constrained optimization model to improve the performance of the BPO company under different planning scenarios; and
3. To solve a stochastic integer program of a constrained optimization model by using multiple scenario trees.

The method and system of the preferred embodiment of the invention then produce as output, in a machine-readable data format:
1. For each parent process-scenario-future period combination, the total headcount, no. of new hires, the number of transitions from parent to affiliate process and the attritions;
2. Also, for each parent process, the expected capacity available as a result of optimal hiring and transition decisions;
3. The capacity variance between the expected demand and the optimal capacity for each parent process;
4. For each affiliate process-scenario-future period combination, the total headcount, no. of new hires, no. of transition-in from parent process, no. of attrition;
5. Also, for each affiliate process, the expected capacity available as a result of optimal hiring and transition decisions; and
6. For each affiliate process, the capacity variance between the expected demand and the optimal capacity for each parent process.

In the domain of workforce management for BPO sector, the only solutions/products available have been target for business processes automation in Voice process space with some level of what-if analysis using crude analytics or a simple high-level simulation. Applying math programming/stochastic programming in an innovative approach has yet to be applied to this field.

Another key value of the preferred embodiment of the present invention is to enable BPO companies to evaluate their capacity to enable them to enter into an optimal revenue sharing agreements with the clients by signing contracts for future work based on precise workforce capability outlook for the future.

Further benefits and advantages of the invention will become apparent from a consideration of the following detailed description, given with reference to the accompanying drawing, which specifies and shows preferred embodiments of the invention.

### BRIEF DESCRIPTION OF THE DRAWINGS

FIG. 1 depicts a system for headcount planning according to a preferred embodiment of the present invention.

FIG. 2 depicts the technical architecture of the headcount planning system.

FIG. 3 shows the relationship (strong/week) between processes.

FIG. 4 depicts parameters impacting the headcount evolution from one period to next.

FIG. 5 shows a headcount planning problem cast as a deterministic (single scenario) state-transition network.

FIG. 6 shows the headcount planning problem cast as a stochastic (multiple scenario) state transition network.

### DETAILED DESCRIPTION OF THE PREFERRED EMBODIMENTS

As indicated above, the present invention provides a method, system and program product for headcount planning for an outsourcing project. Commonly, when a business process is desired to be outsourced from a client (e.g., a company or governmental unit) to a third party outsourcer, an outsourcing project is initially planned. Typically, the plan includes a plurality of overlapping phases that extend over several time periods. Thereafter, a cost for implementing the outsourcing project is estimated. Should the cost exceed a planned budget of the client, the excess/investment is addressed while an agreement between the client and the outsourcer for the outsourcing project is being reached. This can involve reducing scope, restructuring the overlapping phases to reduce or eliminate the excess cost, and/or integrating funding options to address the cost as part of the agreement.

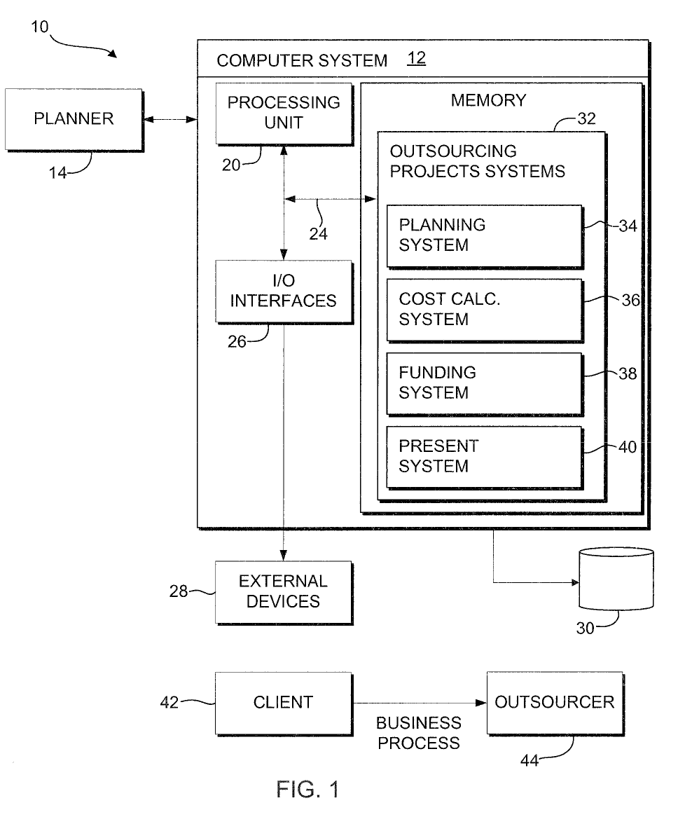

Referring now to FIG. 1, a system 10 for headcount planning for an outsourcing project according to the present invention is shown. As will be further described below, an “outsourcing project” typically pertains to a business function that is being outsourced from a client 42 (e.g., a company or governmental unit) to an outsourcer 44. Examples of business functions include contact centers, accounting operations, human resources services, procurement, etc. Moreover, the term “outsourcing project” under the present invention is intended to mean be any type of outsourcing project such as a Business Process Outsourcing (BPO) project, a Business Transformation Outsourcing (BTO) project, an Information Technology Outsourcing (ITO) project, etc. The term “client” is intended to mean any entity (e.g., individual, company, organization, etc.) that is outsourcing one or more business processes to a third party. The term “outsourcer” is intended to mean any entity that is performing business processes on behalf of a client.

In general, system 10 includes a computer system 12 having a computer-implemented tool/software program (outsourcing project system 32). To plan and fund an outsourcing project, planner 14 will input first a plan for the project by setting forth the parameters (e.g., phases, time periods, costs, etc.) thereof. Based on the inputted plan, a cost of the outsourcing project can be estimated. Should the cost exceed the client's planned budget, planner 14 can plan for the excess. To this extent, planner 14 can be a representative of an entity seeking to outsource a business process (i.e., the client 42), or planner 14 can be a representative of a third party company (e.g., an outsourcer/service provider 44) that will perform the business process on behalf of a client 42.

Computer system 12 is intended to represent any type of computerized device capable of carrying out the teachings of the present invention. For example, computer system 12 could be a desktop computer, a laptop computer, a hand held device, a workstation, a server, a client, etc. To this extent, it should also be appreciated that computer system 12 could be a stand-alone computer system as shown, or it could be implemented over a network such as the Internet, a local area network (LAN), a wide area network (WAN), a virtual private network (VPN), a personal area network (PAN), etc. In the case of the latter, planner 14 could utilize a separate computerized device (e.g., a client) to interface with computer system 12 over the network. Moreover, communication through the network could occur via a direct hardwired connection (e.g., serial port), or via an addressable connection that may utilize any combination of wire line and/or wireless transmission methods. Conventional network connectivity, such as Token Ring, Ethernet, WiFi or other conventional communications standards could be used. Still yet, connectivity could be provided by conventional IP-based protocol. In this instance, an Internet service provider could be used to establish interconnectivity.

Computer system 12 generally includes processing unit 20, memory 22, bus 24, input/output (I/O) interfaces 26, external devices/resources 28 and storage unit 30. Processing unit 20 may comprise a single processing unit, or be distributed across one or more processing units in one or more locations, e.g., on a client and server. Memory 22 may comprise any known type of data storage and/or transmission media, including magnetic media, optical media, random access memory (RAM), read-only memory (ROM), a data cache, a data object, etc. Moreover, similar to CPU 20, memory 22 may reside at a single physical location, comprising one or more types of data storage, or be distributed across a plurality of physical systems in various forms.

I/O interfaces 26 may comprise any system for exchanging information to/from an external source. External devices/resources 28 may comprise any known type of external device, including speakers, a CRT, LED screen, hand-held device, keyboard, mouse, voice recognition system, speech output system, printer, monitor/display, facsimile, pager, etc. Bus 24 provides a communication link between each of the components in computer system 12 and likewise may comprise any known type of transmission link, including electrical, optical, wireless, etc.

Storage unit 30 can be any system (e.g., a database, etc.) capable of providing storage for information under the present invention. Such information could include, among other things, outsourcing project plans, cost calculations, funding options, etc. As such, storage unit 30 could include one or more storage devices, such as a magnetic disk drive or an optical disk drive. In another embodiment, storage unit 30 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 22 of computer system 12 is outsourcing project system 32 (hereinafter project system 32). As indicated above, project system 32 is a computer-implemented tool with which planner 14 will interface to plan an outsourcing project, and address funding therefor. As shown, project system 32 includes planning system 34, cost calculation system 36, funding system 38 and presentation system 40.

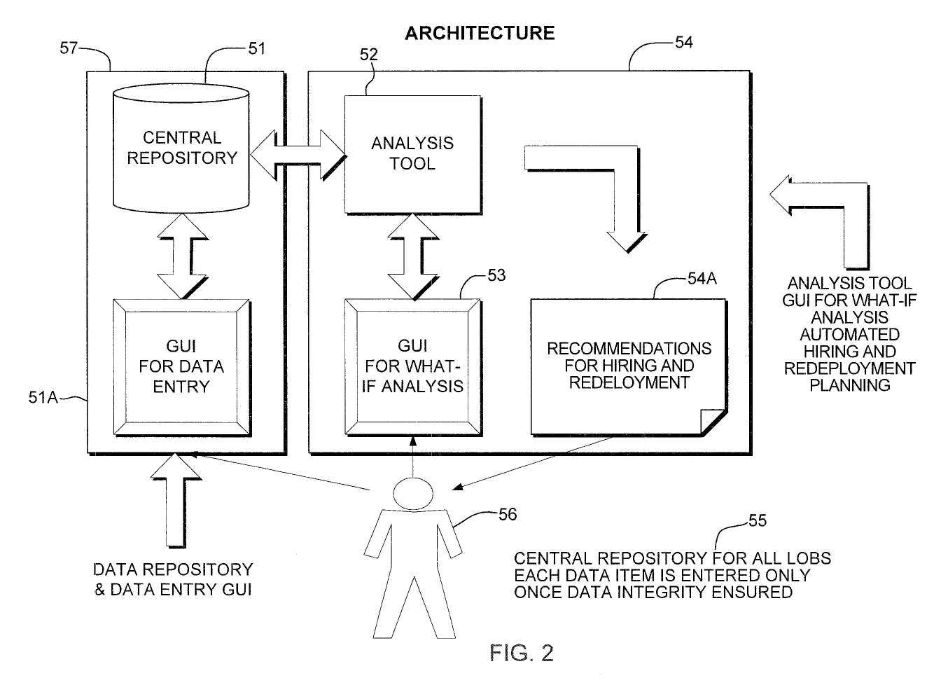

Referring now to FIG. 2, technical architecture of the headcount planning tool implementation is shown using 54 and 57. 57 represent the data repository and the data entry graphical user interface. 54 represent the Analysis workbench and the analysis tool. 51 represents the Central data repository that stores the input and output data for the headcount planning application. This repository can be built using any off-the-shelf hierarchical or relational databases. 51A represents the graphical user interface used to enter the detailed inputs that store information regarding the processes, the agents, claim details for each process and detailed productivity and attrition information regarding the agents. 52 represents the analysis tool. This tool contains the computer understandable machine language implementation of the stochastic headcount planning tool. 53 represents the graphical user interface that enables user to perform the analysis. The user enters the headcount planning input parameters, define what-if scenarios and assign probability to the scenarios. Also the recommendations for hiring and redeployment of resources in 54A can be viewed using 53. 56 represents the user that performs the data entry and analysis for optimal workforce hiring and transition decisions.

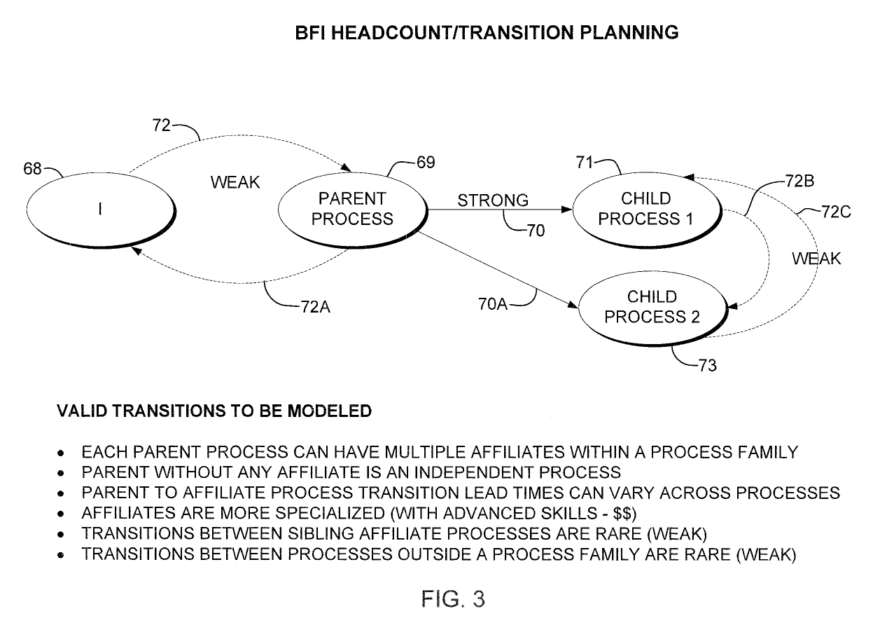

Referring now to FIG. 3, valid transition relationship among processes is shown. 68 shows the set of process families. 69 shows the parent process, and 71 and 73 as the two child (affiliate) processes of the parent process 69. Hence, 69, 71 and 73 form a process family. 72 and 72A describe the weak transition link of agents from and to one process family to another. A weak transition link implies that the transition time is equal to the time taken to hire a new agent. A strong transition link implies that the transition time is less than the time taken to hire a new agent and hence improvement in productivity occurs if the agent transition occurs on the strong transition link processes. 70 and 70A describe a strong transition link between the parent process 69 and the two affiliates 71 and 73. Lastly, 72B and 72C describe the weak transition link between the two child processes 72B and 72C.

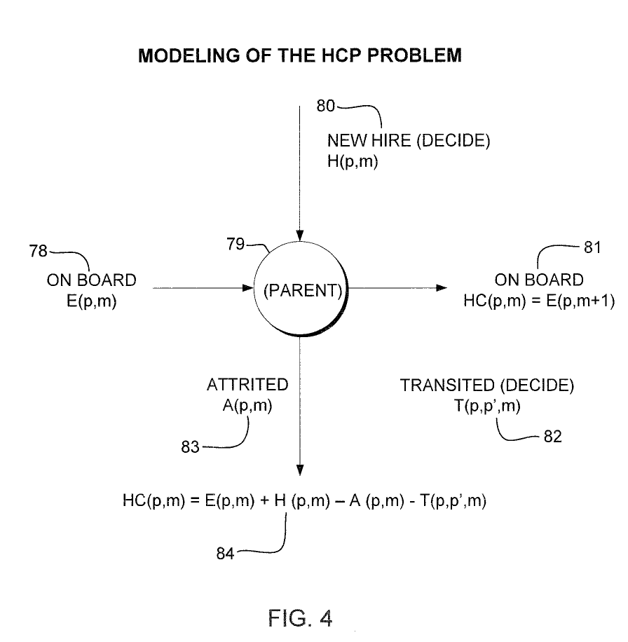

FIG. 4 shows the monthly decision scope for a given process. The headcount at the end of the month m for a process p, HC(p,m) in 81 is the sum of the employees currently working on the process during the month 78, E(p,m), new hires during the month 80, H(p,m), minus the employees leaving the company 83, A(p,m) and the ones transitioned to affiliate processes 82, T(p,p′,m). Hence, optimal hiring and transition decisions are key to meeting the process demands and increasing the revenue. Since there are uncertainties associated with the future demand, stochastic programming is preferably used to model the uncertainty. Scenario based optimization has been applied wherein scenario trees are used to evaluate the impact of uncertain demand on the decision-making.

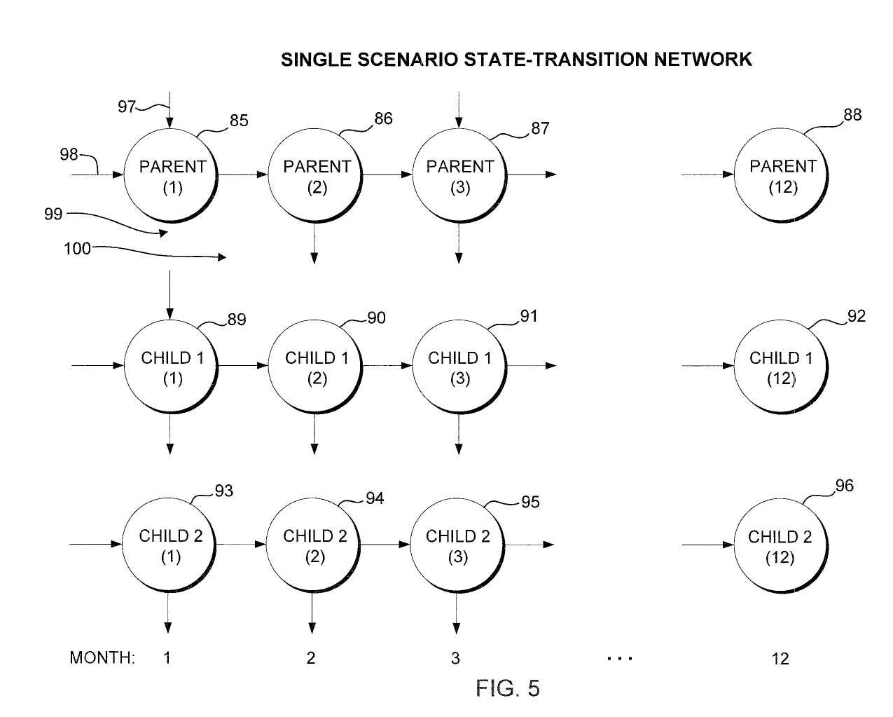

FIG. 5 shows a single scenario state-transition network representation of the headcount planning transition flow. 97 represents the new hiring, 98 represents the employees in the same process from pervious period, 99 represents the employees leaving the company and 100 represents the employees transitioned from parent process to affiliate processes. The figure describes these decision scopes as a function of time. 85, 86, 87 and 88 represent the parent process headcount evolution over time. In this case, the time is measured in months and, hence, each of 85, 86, 87 and 88 represents the state of the process at a given month. Similarly, 89, 90, 91 and 92 represent the process state for child process 1; and 93, 94, 95 and 96 represent the process state for child process 2. Thus, FIG. 5 represents the workforce evolution over time for a single scenario (deterministic).

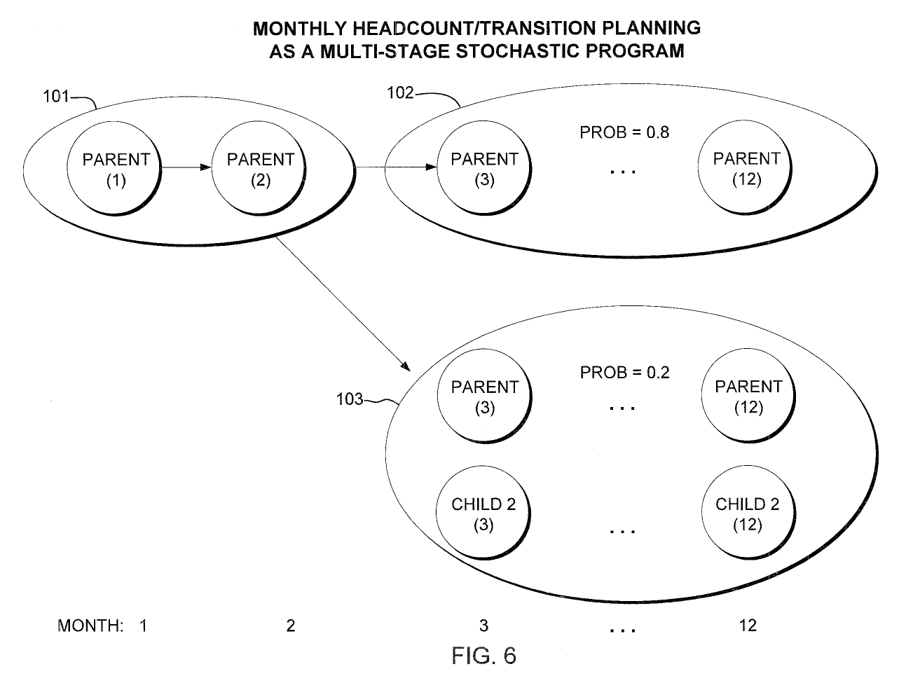

FIG. 6 presents the stochastic view of the headcount and transition planning decision. 101 represents a deterministic scenario where in the parent process has deterministic parameter values for periods 1 and 2. 102 represents a stochastic scenario having a probability of 0.8 from period 3 to 12. 103 represents another stochastic scenario having probability of 0.2. This scenario also involves an affiliate (child) process. To make the optimal headcount planning decision in presence of multiple scenarios, this problem is cast as a multi-stage stochastic programming problem. Using stochastic programming approach enables a incorporating real world uncertainty into the decision making process.

As mentioned above, Business Process Outsourcing companies depend on a highly skilled workforce to deliver services to their clients. For these companies, effective workforce planning is a key to delivery excellence and revenue growth. The present invention addresses this issue by providing a solution for headcount planning (hiring and transition) necessary to meet the business growth targets for a planning horizon.

In the Business Process Outsourcing environment, each business process is managed by one or more batches. A batch is a set of employees that have same productivity as measured in CPH (Claims processed per hour). Also, each business process has a parent process and one or more affiliate processes. Affiliate processes need advanced/specialized skills and hence command higher revenue. As a business rule, agents are moved from parent process to affiliate processes over time. Parent to affiliate transition times vary across processes. Transition between sibling affiliate processes and also to outside processes are rare. Each process has a demand profile measured as the number of claims to be processed each month. Also, each client has signed service level agreements and penalties associated with not meeting the SLAs. Additional penalties are associated with over capacity (as a result of ambitious hiring). Both fixed and variable costs are used to evaluate the cost constraints. Productivity ramp-ups are used to model the level of expertise and measure performance of both new hires and current employees. Industry/market attrition rates for employees are also used as input to the model.

Using the above-mentioned inputs, the model performs an evaluation of the management objectives (e.g. one objective could be to minimize the total cost. In this case, the model will minimize the sum of new hire cost, training cost, transition costs, excess capacity penalty, unmet demand/unmet SLA penalty). It proposes a future hiring and transition plan for each process and month in the planning horizon.

The Math programming formulation used to model the business problem can be stated as follows: Minimize Expected [Business Metric], Subject to: Process handling requirements (demand); Process family evolution scenario tree (multi-stage); SLAs by process and time period; Budget restrictions; and Hiring and transition policies; attrition (supply).

The preferred embodiment of the invention, described above, provides a number of important advantages. For instance, this invention provides Robust business planning across multiple processes; Higher Average Revenue per Agent; Optimum Head Count levels in each process in light of uncertain demands and high attrition levels; and Optimal revenue sharing agreements when clients share Business Intelligence. The stochastic programming model looks at the current workforce deployed to the processes and based on the expected demand scenarios, computes the optimal number of new hires needed to meet the demand. It uses scenario trees to analyze the uncertainty associated with the future demand.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of planning a workforce headcount for a given business process, the method comprising the steps of:
providing as inputs, i) productivity ramp-ups to model the level of experience and to measure the performance of both new hires and current employees, and ii) industry/market attrition rates for employees;
performing an evaluation, using said inputs, of at least one given management objective; and
on the basis of said evaluation, providing a future hiring and transition plan for the given business process for a defined period of time.

2. A method according to claim 1, wherein uncertainty is associated with one or more of the inputs, and wherein the step of providing a future hiring and transition plan includes the step of using stochastic programming to model the uncertainty associated with at least one of said one or more of the inputs.

3. A method according to claim 2, wherein the step of providing a future hiring and transition plan further includes the step of using one or more scenario trees to evaluate the impact of uncertain demand on the decision making process.

4. A method according to claim 3, wherein the step of using stochastic programming includes the step of computing an optimal number of new hires needed to meet an expected demand.

5. A method according to claim 4, wherein the step of using one or more scenario trees includes the step of using one of the scenario trees to analyze the uncertainty associated with the future demand.

6. A method according to claim 1, wherein the step of providing a future hiring and transition plan includes the step of determining a headcount for the specified period based on a number of given factors including the sum of i) the employees currently working on the process, and ii) new hires during said period.

7. A method according to claim 6, wherein said given factors further include the number of employees leaving during said period.

8. A method according to claim 7, wherein said given factors further include the number of employees transitioning to affiliated processes.

9. A method according to claim 1, wherein the given management objective is to minimize the cost of a defined set of parameters.

10. A method according to claim 1, wherein the given management objective is to minimize the sum of new hire cost, training cost, excess capacity penalty, and unmet demand/unmet service level agreement penalties.

11. A system for planning a workforce headcount for a given business process, the system comprising at least one processor unit configured for:
receiving as inputs, i) productivity ramp-ups to model the level of experience and to measure the performance of both new hires and current employees, and ii) industry/market attrition rates for employees;
performing an evaluation, using said inputs, of at least one given management objective; and
on the basis of said evaluation, providing a future hiring and transition plan for the given business process for a defined period of time.

12. A system according to claim 11, wherein uncertainty is associated with one or more of the inputs, and wherein said one or more processor units is configured for providing the future hiring and transition plan by using stochastic programming to model the uncertainty associated with at least one of said one or more of the inputs.

13. A system according to claim 12, wherein the one or more processor units are configured for providing the future hiring and transition plan further by using one or more scenario trees to evaluate the impact of uncertain demand on the decision making process.

14. A system according to claim 11, wherein the one or more processor units are configured for providing the future hiring and transition plan by determining a headcount for the specified period based on a number of given factors including i) the employees currently working on the process, ii) new hires during said period, iii) the number of employees leaving during said period, and iv) the number of employees transitioning to affiliated processes.

15. A system according to claim 11, wherein the given management objective is to minimize the sum of new hire cost, training cost, excess capacity penalty, and unmet demand/unmet service level agreement penalties.

16. An article of manufacture comprising
at least one computer usable medium having computer readable program code logic to execute a machine instruction in a processing unit for planning a workforce headcount for a given business process, said computer readable program code logic when executing performing the following steps:
receiving as inputs, i) productivity ramp-ups to model the level of experience and to measure the performance of both new hires and current employees, and ii) industry/market attrition rates for employees;
performing an evaluation, using said inputs, of at least one given management objective; and
on the basis of said evaluation, providing a future hiring and transition plan for the given business process for a defined period of time.

17. An article of manufacture according to claim 16, wherein uncertainty is associated with one or more of the inputs, and wherein the step of providing a future hiring and transition plan includes the step of using stochastic programming to model the uncertainty associated with at least one of said one or more of the inputs.

18. An article of manufacture according to claim 17, wherein the step of providing the future hiring and transition plan further includes the step of using one or more scenario trees to evaluate the impact of uncertain demand on the decision making process.

19. An article of manufacture according to claim 16, wherein the step of providing the future hiring and transition plan includes the step of determining a headcount for the specified period based on a number of given factors including i) the employees currently working on the process, ii) new hires during said period, iii) the number of employees leaving during said period, and iv) the number of employees transitioning to affiliated processes.

20. An article of manufacture according to claim 16, wherein the given management objective is to minimize the sum of new hire cost, training cost, excess capacity penalty, and unmet demand/unmet service level agreement penalties.
